(19) United States
(12) Patent Application Publication
(10) Pub. No.: US 2026/0004234 A1
(43) Pub. Date: Jan. 1, 2026

(54) LOGISTICS LOADING WORK CONTROL SYSTEM AND METHOD

(71) Applicants: Hyundai Motor Company, Seoul (KR); Kia Corporation, Seoul (KR)

(72) Inventors: Jongho Shin, Hwaseong (KR); Se Do Oh, Hwaseong (KR); Minkooc Wee, Hwaseong (KR); Sunkyung Choi, Hwaseong (KR); You Jin Shin, Hwaseong (KR)

(21) Appl. No.: 19/240,978

(22) Filed: Jun. 17, 2025

(30) Foreign Application Priority Data
Jun. 28, 2024 (KR) 10-2024-0084922

(51) Int. Cl. G06Q 10/087; G06F 3/04817; G06K 7/14; G06Q 10/04

(52) U.S. Cl. CPC G06Q 10/087; G06F 3/04817; G06K 7/1417; G06Q 10/043

(57) ABSTRACT

A logistics loading work control system includes a server configured to mirror facility data of an actual logistics facility and a virtual environment, for example, based on a digital twin. The system also includes a packaging simulator configured to calculate cargo information corresponding to a loading area received from the server through a loading algorithm and predict priority cargo information in a sequence of highest loading efficiency with respect to a current work-target cargo container, and a worker terminal configured to assist a logistics loading work of a worker by deriving a scenario branch-type loading sequence and an expected loading rate based on a logistics loading situation inside the loading area through the packaging simulator and providing a recommended cargo logic according to the derived result.

### CROSS-REFERENCE TO RELATED APPLICATION

This application claims under 35 U.S.C. § 119 (a) the benefit of Korean Patent Application No. 10-2024-0084922 filed with the Korean Intellectual Property Office on Jun. 28, 2024, the entire contents of which are incorporated herein by reference.

### BACKGROUND

### (a) Technical Field

The present disclosure relates to a logistics loading work control system and method, more particularly, to the logistics loading work control system and method for assisting logistics loading work of workers in a logistics terminal.

### (b) Description of the Related Art

Conventional logistics technology is typically divided into three types, i.e., logistics automated facilities, logistics loading algorithms, and logistics line monitoring (e.g., enterprise resource planning, ERP) systems.

Recently, logistics terminals have introduced logistics automated facilities for entering, storing, and releasing cargo, and control facilities for on-site facility operation. Accordingly, logistics terminals have introduced logistics loading algorithms in order to achieve efficient operation between logistics automated facilities. However, conventionally, workers for individual operations are required for different types of logistics facilities, and mobile applications for workers are limited to managing the work history and notifying logistics entry/release through barcode readers.

In addition, conventional logistics loading algorithms depend on the experience (skill) of workers for loading cargo inside a cargo vehicle container, an aircraft unit load device (ULD), and/or a ship container. However, according to these cargo loading methods, cargo loading efficiency can vary depending on the experience of the workers.

For example, when loading cargo into a limited space inside a cargo container (container/ULD), if the worker's experience is low, the problem of deterioration the loading efficiency and safety (e.g., bias/collapse, or the like) may be caused. When there is deterioration of the loading efficiency and the stability occurs, since there may be a cargo damage or relocation must be repeated, there is a disadvantage in that loading working man-hours, time, and cost may increase. In particular, when the size and shape of cargo containers, and the volume and weight of cargos are variable depending on cargo vehicles, aircraft, and vessels, the conventional method depending on the worker's experience may have a disadvantage in that the optimal cargo loading efficiency cannot be ensured.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a logistics loading work control system and method capable of providing a priority recommended cargo according to a plurality of expected loading rates to the worker by being linked with a server of a logistics terminal through wireless communication to install a work instruction application (APP) for assisting a cargo loading work of a worker and by performing a loading algorithm for an optimal loading work instruction in a given environment and a scenario branch-type algorithm.

According to the present disclosure, a logistics loading work control system may include: a server configured to mirror facility data of an actual logistics facility and a virtual environment; a packaging simulator configured to calculate cargo information corresponding to a loading area received from the server through a loading algorithm and predict priority cargo information in a sequence of highest loading efficiency with respect to a current work-target cargo container; and a worker terminal configured to assist a logistics loading work of a worker by deriving a loading sequence and an expected loading rate based on a logistics loading situation inside the loading area through the packaging simulator and providing a recommended cargo logic according to the derived result.

According to another aspect of the present disclosure, a logistics loading work control system may include a server configured to mirror facility data of an actual logistics facility and a virtual environment based on a digital twin, a packaging simulator configured to calculate a cargo information a loading area received from the server through a loading algorithm and predict priority cargo information in a sequence of highest loading efficiency with respect to a current work-target cargo container, and a worker terminal configured to assist a logistics loading work of a worker by deriving a scenario branch-type loading sequence and an expected loading rate based on a logistics loading situation inside the loading area through the packaging simulator and providing a recommended cargo logic according to the derived result.

The packaging simulator may be integrated into the server or installed in the worker terminal in an on-board format or by installing a client service program APP.

The worker terminal may be configured to display the priority cargo information and a plurality of expected loading rates derived through the loading algorithm of the packaging simulator through a graphical user interface (GUI) so that the worker's selection is enabled, and receive the specific cargo information selected by the worker and transmit a loading work instruction to the server.

The worker terminal may include a communication unit connected to the server or an ERP system through wireless communication to transmit/receive data required for the logistics loading work, an input unit configured to input the cargo information of a current loading area collected through the communication unit as a condition for the loading algorithm execution, a calculation unit configured to execute the loading algorithm according to an input condition to calculate the loading sequence and a disposal location of the cargo, a GUI configured to visualize and output various information for controlling the cargo loading work of the worker, and a controller installed with a work instruction application APP for assisting the logistics loading work of the worker, and configured to control the loading algorithm for the loading work instruction in a current situation of the loading area and a scenario branch-type algorithm for deriving the plurality of expected loading rates.

The communication unit may be configured to collect the cargo information located in the loading area and operation state of the logistics facility from the server and collect the cargo shipment information computerized by being linked with the ERP system.

In an environment in which wireless communication with the server is not possible, the input unit may input the cargo information in a manner of loading pre-defined information through a barcode or QR scan function.

The GUI may be configured to display on a screen at least one of the expected loading rate derived according to the loading algorithm, a recommended priority cargo, a loading-prohibited cargo, a location of a touch interface operation unit, a loading confirmation button, or a loading location of the selected cargo.

The GUI may be configured to display a loading platform position and loading platform ID existing in the loading area through a loading area view screen, and output a correct insertion rate status with respect to the current work-target cargo container in the form of a graph or percentage.

The GUI may be configured to display information on at least one of the expected loading rate of the cargo, whether the cargo can be loaded, whether the cargo is broken down, or a priority recommended cargo with respect to each loading platform, in the form of icons, and in the case of recommended cargos classified according to a recommended cargo selection logic, derive a recommended icon graphic resource and the expected loading rate into a 3D scene.

When the worker selects a specific cargo among loading platform icons that can be selected from the loading area view screen, the GUI may be configured to output detailed information on the corresponding cargo.

The GUI may be configured to output the disposal location considering loaded status inside the cargo container with respect to the cargo selected by the worker, and work status information including a loading rate of a current cargo container, a work time, and shipment properties, through a cargo container loading location view screen.

According to the present disclosure, a logistics loading work control method of a worker terminal, being linked with a server of a logistics terminal, includes: loading, by the worker terminal, shipment state and accumulated shipment properties of a current work-target cargo container, through the server; filtering, by the worker terminal, shipment-prohibited cargos through inspection of shipment properties of the cargo existing in a loading platform of a loading area to classify a loadable cargo; branching, by the worker terminal, a scenario targeting the loadable cargo and deriving disposal coordinates with respect to a subsequent loadable cargo; performing, by the worker terminal, a loading algorithm calculation utilizing a packaging simulator based on the branched scenario to derive an expected loading rate for each scenario branch; sorting, by the worker terminal, the expected loading rate for each derived scenario branch with respect to each corresponding cargo; and outputting, by the worker terminal, a priority recommended cargo matching a recommended cargo logic through a graphical user interface (GUI).

According to a further aspect of the present disclosure, a logistics loading work control method of a worker terminal, the method being linked with a server of a logistics terminal may include loading shipment state and accumulated shipment properties of a current work-target cargo container, through the server, filtering shipment-prohibited cargos through inspection of shipment properties of the cargo existing in a loading platform of a loading area to classify a loadable cargo, branching a scenario targeting the loadable cargo and deriving disposal coordinates with respect to a subsequent loadable cargo, performing a loading algorithm calculation utilizing a packaging simulator based on the branched scenario to derive an expected loading rate for each scenario branch, and sorting the expected loading rate for each derived scenario branch with respect to each corresponding cargo and outputting a priority recommended cargo matching a recommended cargo logic through graphical user interface (GUI).

The logistics loading work control method may further include, after the outputting the priority recommended cargo through the GUI, transmitting a loading work instruction of the specific cargo to the server, when a specific cargo is selected through the GUI by a worker.

The branching the scenario targeting the loadable cargo may include limiting the number of scenario branches through a separate rule based on a calculation load of the packaging simulator.

The deriving the expected loading rate for each scenario branch may further perform a loading algorithm calculation based on a cargo information being standby in an automated warehouse or existing in entry reservation information to derive the expected loading rate for each scenario branch.

The deriving the expected loading rate for each scenario branch may include loading a loaded cargo of the loading platform, a loaded cargo of the cargo container, and a stored cargo of an automated warehouse, through the packaging simulator, generating 3D coordinates of the loaded cargo container and calculating the loadable cargo list target coordinates, determining a disposal-target cargo inside the cargo container based on a value of a determination function of a lower unit applied with priority assignment, lower disposal, and avoidance rule, inspecting whether the disposal-target cargo and the loaded cargo of the cargo container overlap in a physical space, and modifying the disposal location when a physical space overlap occurs, and calculate a loading weight and expected loading rate of the cargo container based on information of a generator library database including three conditions of a cargo library, a cargo container library, and simulation scheduling.

The determining the batch cargo may include determining double loading prohibition, shipment properties, and a transit location, priority assignment balancing, for disposing a regular cargo in a lower portion and an irregular cargo in an upper portion, solid/heavy weight balancing, for preferentially disposing a solid and heavy weighted cargo in the lower portion, and calculating whether the disposed cargo is broken down.

The outputting the priority recommended cargo through the GUI may include further displaying at least one of the expected loading rate derived according to the loading algorithm, a loading-prohibited cargo, a location of a touch interface operation unit, a loading confirmation button, or a loading location of the selected cargo.

The outputting the priority recommended cargo through the GUI may include, when the worker selects a specific cargo among loading area view screen of loading platform icons that can be selected from the GUI, outputting detailed information on the corresponding cargo.

The outputting the priority recommended cargo through the GUI may include outputting the disposal location considering loaded status inside the cargo container with respect to the cargo selected by the worker, and work status information including a loading rate of a current cargo container, a work time, and shipment properties, through a cargo container loading location view screen of the GUI.

### BRIEF DESCRIPTION OF THE DRAWINGS

FIG. 1 schematically shows a configuration of a digital twin-based logistics loading assist system according to an embodiment.

FIG. 2 is a schematic view showing an example of facility operation of a logistics terminal according to an embodiment.

FIG. 3 shows a loading work area environment and a loading work control state of the worker terminal according to an embodiment.

FIG. 4 is a block diagram schematically showing a configuration of a worker terminal according to an embodiment.

FIG. 5 shows a flow of a loading algorithm utilizing a packaging simulator according to an embodiment.

FIG. 6 shows a cargo container 3D coordinates and cargo dimension pivot state according to an embodiment.

FIG. 7 shows a batch cargo overlap inspection method according to an embodiment.

FIG. 8 shows calculation of weight/loading rate and loading sequence of cargos, and a coordinate logging method according to an embodiment represent.

FIG. 9 shows a loading area loading platform-based scenario branch-type algorithm applied to a worker terminal according to an embodiment.

FIG. 10 shows a GUI output form of a worker terminal in a loading work according to an embodiment.

FIG. 11 shows an additional function applied to a GUI of a worker terminal according to an embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure will be described more fully hereinafter with reference to the accompanying drawings, in which exemplary embodiments of the disclosure are shown.

The terminology used herein is for the purpose of describing particular embodiments only and is not intended to be limiting of the present disclosure. As used herein, the singular forms are intended to include the plural forms as well, unless the context clearly indicates otherwise.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the term.

In this specification, it is to be understood that when one component is referred to as being “connected” or “coupled” to another component, it may be connected or coupled directly to the other component or be connected or coupled to the other component with a further component intervening therebetween. In this specification, it is to be understood that when one component is referred to as being “connected or coupled directly” to another component, it may be connected to or coupled to the other component without another component intervening therebetween.

Throughout the specification, the terms used herein are only used to describe certain embodiments and are not intended to limit the present disclosure. Singular expressions are intended to include plural forms as well, unless the context clearly dictates otherwise.

In addition, it is understood that one or more of the following methods or aspects thereof may be carried out by at least one controller. The term “controller” may refer to a hardware device including a memory and a processor. The memory is configured to store program instructions, and the processor is specifically programmed to execute the program instructions to perform one or more processes which are described further below. The controller may control operations of units, modules, components, devices, or the like, as described herein. In addition, it is understood that the following methods may be carried out by an apparatus including the controller as well as one or more other components, as recognized by those skilled in the art.

A logistics loading assist system and method according to an embodiment will be described in detail with reference to the drawings.

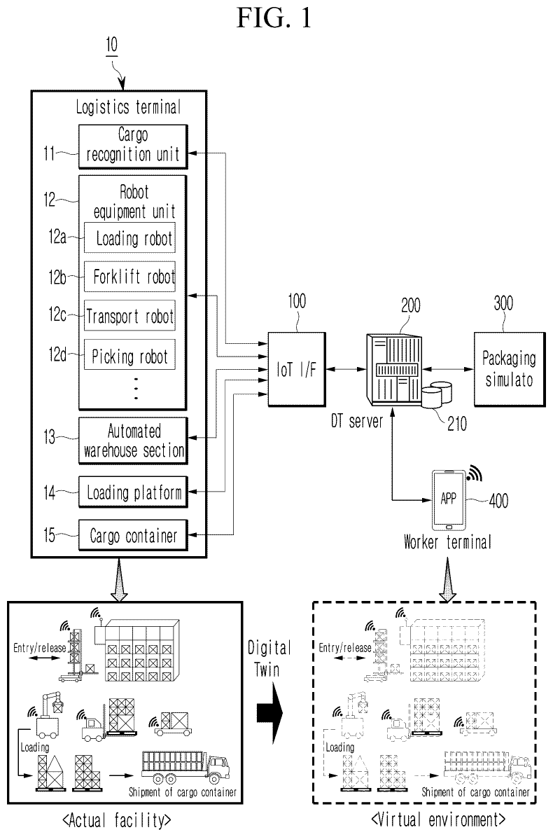

FIG. 1 schematically shows a configuration of a digital twin-based logistics loading assist system according to an embodiment.

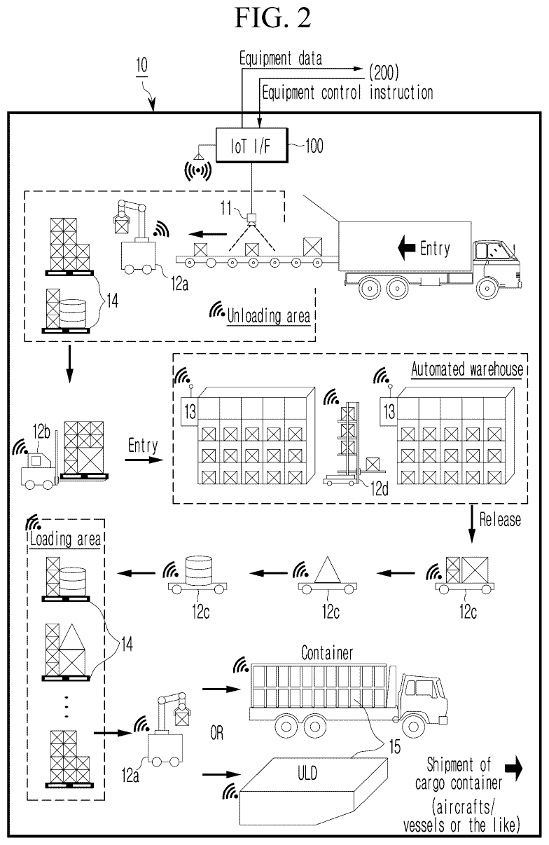

FIG. 2 is a schematic view showing an example of a facility operation of a logistics terminal according to an embodiment.

Referring to FIG. 1 and FIG. 2, a digital twin-based logistics loading assist system according to an embodiment may include an Internet of Things interface (IoT I/F) 100, a server 200, a packaging simulator 300, and a worker terminal 400.

The IoT I/F 100 may support heterogeneous communication protocols with respect to various automated logistics facilities 11, 12, 13, 14, and 15 operated in a logistics terminal 10 and may collect facility data in real time.

The server 200 may mirror the facility data of the actual (real environment) logistics facilities 11, 12, 13, 14, and 15 and a virtual environment, according to the facility data uploaded from the IoT I/F 100 based on a digital twin (DT).

The packaging simulator 300 may derive an optimal cargo deployment sequence and disposal location within a designated space through a loading algorithm utilizing the facility data of the server 200.

The worker terminal 400 may provide a graphical user interface (GUI) screen enabling instructing loading sequence of the cargo matching with simulation result of the packaging simulator 30 and an optimal loading work within the designated space (container/ULD or the like).

Here, the facility data may include all operation facilities provided in the logistics terminal 10 and their state information. For example, the state information of the facilities may include at least one of a type (model), a unique identification information (ID), a number, a location, an operability, or an operating state, of the operated facility.

In addition, the packaging simulator 300 may be implemented in an independent computer system to be linked with through a web or integrated into the server 200 to provide the loading algorithm function to the worker terminal 400. However, an embodiment is not limited thereto, and the loading algorithm function of the packaging simulator 300 can be installed in the worker terminal 400 in an on-board format or by installing a client service program APP.

The logistics terminal 10 according to an embodiment may be a logistics platform in which various logistics items that can be transported by aircrafts or vessels are received, stored, released according to a schedule, and then shipped, and may include an enterprise resource planning (ERP).

The logistics terminal 10 may operate various logistics facilities including a cargo recognition unit 11, a robot equipment unit 12, an automated warehouse 13, a loading platform 14 and a cargo container 15, or the like.

The cargo recognition unit 11 may measure unique identification information (hereinafter, referred to as “the cargo ID”), volume (including the shape) and weight, or the like, of the received cargo, through various measurement devices. For example, the cargo recognition unit 11 may recognize the cargo ID from a tag (e.g., barcode, QR code, RFID, NFC, or the like of the received cargo through a reader, and may measure a cargo volume, a weight, and a 3D point cloud through a 3D vision connected to a conveyor. At this time, the cargo recognition unit 11 may generate a 3D mesh modeling file based on the cargo ID, the cargo volume, the weight and 3D point cloud.

The IoT I/F 100 may upload the recognized cargo information, including the 3D mesh modeling file, to a database table of the server 200. In addition, the IoT I/F 100 may share the cargo information by transmitting it to ERP configured to manage entry/release reservation information of the cargo.

The robot equipment unit 12 may include a loading robot 12a, a forklift robot 12b, a transport robot 12c, and a picking robot 12d, or the like, for handling the cargo, and all the robots may include a sensor and a IoT communication means for detecting surroundings.

The loading robot 12a may grip the cargo and load it to the designated space (location). For example, the loading robot 12a may load the cargo on the loading platform 14 or load it in a space within the cargo container 15. The loading robot 12a may grip the cargo and load it to a designated location through an articulated manipulator and a gripper according to the received instruction.

The forklift robot 12b may lift the loading platform 14 on which the cargos are loaded by using a fork, and transport it to the designated location (e.g., loading area/the cargo container). In addition, the forklift robot 12b may directly load the cargo in a state loaded on the loading platform 14 in the cargo container 15.

The transport robot 12c may load at least one cargo in an upper portion, and transport it to the designated location. For example, the transport robot 12c may transport the received cargo to the automated warehouse 13 or transport the cargo released from the automated warehouse 13 to the loading area. The transport robot 12c may include at least one of an autonomous mobile robot (AMR) or an automated guided vehicle (AGV).

The picking robot 12d may serve to pick or release the cargo from the automated warehouse 13 of a warehouse rack structure according to the received instruction. The picking robot 12d may load a plurality of cargos in a multi-stage structure, and input the cargo into or retract the cargo from a cell space of the automated warehouse 13 through lifting/lowering and forward/backward actuators.

In addition, the robot equipment unit 12 may further include, generally, various additional equipment, such as a stacker crane, a crane, a fork actuator, or the like, that can be utilized by being installed in the automated warehouse of the logistics terminal 10.

The automated warehouse 13 may store the cargo in the cell space of a multi-layer structure and may identify the real-time cargo storing information through a sensor and transmit the identified information to the IoT I/F 100. The cargo storing information may include at least one of the cargo ID, entry date, entry sequence, or an idle warehouse rack location. The sensor may include at least one of an IoT sensor, a vision sensor, an infrared sensor, or a piezoelectric sensor, and may detect whether the cargo is to be stored.

The automated warehouse 13 may identify the real-time cargo storing information and the idle cell space for each cell location based on the cargo picking and release information of the picking robot 12d. The automated warehouse 13 may include a warehouse controller configured to automate all works such as entry/release, management, picking, classification, or the like of the cargo, by utilizing peripheral equipment and sensors.

The loading platform 14 may load a regular or irregular cargo in a cargo loading space of a pallet structure and may have a forklift pick-up structure. Here, the regular cargo may refer to a cargo that is easy to load because it has a regular structure, such as a company's product packaging box. In contrast, the irregular cargo may refer to a cargo that is not easy to load due to its non-standard, irregular structure (shape) and volume.

The loading platform 14 may measure the cargo loading information through a unique loading platform ID and a sensor and transmit the measured information to the IoT I/F 100. The cargo loading information may include the cargo ID, volume, weight, and loading space information of the loaded cargo.

The cargo container 15 may include a container and a unit load device (ULD) capable of loading the cargo of a large amount, and may have a size and shape that can be shipped depending on a transport vehicle such as a vessel and/or an aircraft.

The same as the loading platform 14, the cargo container 15 may measure the cargo loading information through the cargo container ID and the sensor and transmit the measured information to the IoT I/F 100.

The IoT I/F 100 may have a protocol compatible with a control means of each logistics facility, and may upload logistics information required for the server 200 to a database table.

The server 200 may be a center system for the digital twin-based automated logistics facility operation, and may serve to relay data transmission/reception between the IoT I/F 100, the packaging simulator 300 and the worker terminal 400.

The server 200 may link a cyber-physical systems (CPS) mode of the virtual environment mirrored with the logistics terminal 10 based on a digital twin and a control function of a simulation mode of predicting operation efficiency according to modifying of facility operation condition (e.g., number, location, type, or the like of the equipment) of the virtual environment through the packaging simulator 300 to the worker terminal 400 in the form of a switching structure.

The CPS mode may dispose a virtual object generated based on the 3D mesh modeling file within the virtual environment simulating the actual logistics terminal 10, and may provide mirrored information by processing real-time synchronization on the facility data of an actual environment.

For example, the server 200 may convert the facility data collected in real time at the time of the CPS mode into a motion sequence within the virtual environment and display the converted motion sequence to the user in the virtual environment mirroring animation. In addition, a DT server 200 may analyze a difference in the simulation result when the cargo of the same condition is operated in the simulation and output various meaningful facility operation indicators.

The server 200 may store various program and data required for the system operation in a database (DB) 210, and may convert the data generated according to the operation into the database 210. For example, the DB 210 may store and manage the cargo information inside the logistics terminal, the facility data, and simulation result in respective database tables.

The worker terminal 400 may be defined as a work instruction system configured to control the cargo loading work of the logistics terminal through the simulation mode and the CPS mode of the server 200.

For example, the worker terminal 400 may instruct an entering work, a releasing work and a loading work of the designated cargo by being linked with the server 200. The entering work may include a series of processes for loading the received cargo on the loading platform, and transporting and picking it to the automated warehouse 13. The releasing work may refer to releasing the cargo from the automated warehouse 13. The loading work may include a work for loading the cargo in the loading platform 14 of the work area and/or the designated space of the cargo container 15.

In addition, the worker terminal 400 may instruct an instruction for a loading sequence, a releasing sequence, and an optimal loading work within the designated space (container/ULD or the like) of the received cargo through the loading algorithm.

In addition, the worker terminal 400 may reproduce (replay) a black box image as a simulation based on the cargo log and the time chart of the object by logging a loading work result into the DB 210.

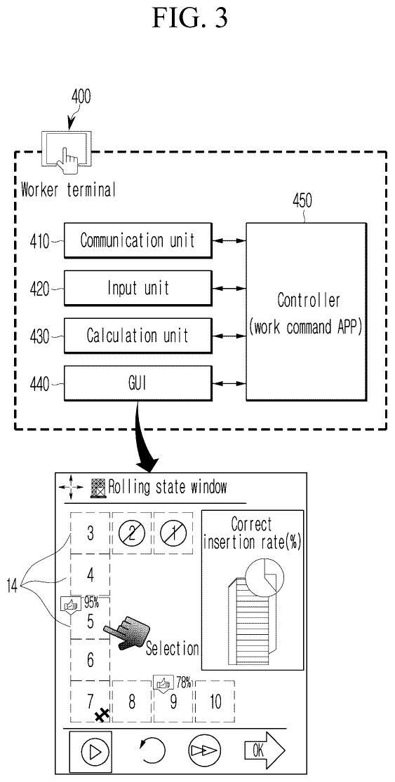

FIG. 3 shows a loading work area environment and a loading work control state of the worker terminal 400 according to an embodiment.

Referring to FIG. 3, loading work area (hereinafter, referred to as “the loading area”) according to an embodiment includes a plurality of loading platforms 14 (here, the loading platform IDs 1 to 10 are shown) for locating loading work-target cargos and the cargo container 15 forming a loading work-target space.

In such a loading area, the worker terminal 400 may control the loading work by being linked with the server 200 and the packaging simulator 300.

The server 200 may extract the cargo information existing in the loading platform 14 inside the loading area, and transfer it to the packaging simulator 300. That is, the server 200 stores the cargo information for each of loading platform IDs (e.g., 1 to 10) having an identification code or name inside the loading area, may transfer the cargo information required for the loading algorithm to the packaging simulator 300. The server 200 has digital twin-based real-time cargo monitoring information. For example, the cargo monitoring information may include a loaded status of the cargo disposed in the interior space of a current work-target cargo container 15, pieces of shipment information related to the cargo ID being standby in the loading area, and subordinate cargo available at the logistics terminal 10 other than the automated warehouse or the loading area.

The packaging simulator 300 may calculate the cargo information the loading area received from the server 200 through the loading algorithm and predict priority cargo information in a sequence of highest a plurality of expected loading efficiencies (hereinafter, also referred to as “loading rate”) with respect to the current work-target cargo container 15. In addition, it may derive the cargo ID and loading location with respect to the priority cargo information and a plurality of expected loading rates.

The worker terminal 400 may display the priority cargo information and the plurality of expected loading rates derived through the loading algorithm of the packaging simulator 300 through a GUI so that the worker's selection is enabled. At this time, the worker terminal 400 may display the cargo ID and loading location according to the plurality of expected loading rates and the priority cargo information through a GUI on a work instruction APP to alert the worker. In addition, the worker terminal 400 may receive the specific cargo information (the cargo ID and loading location) selected by the worker and transmit a loading work instruction to the server 200.

Accordingly, the server 200 may control the loading work of the logistics facility through the IoT I/F 100 according to the received loading work instruction. In addition, the real-time work status and result mirrored with an actual logistics facility may be provided to the worker terminal 400, to provide the real-time loading work status monitoring function.

Thereafter, the worker terminal 400 may repeat the above branch algorithm until the cargo loading work with respect to the cargo container 15 is completed, thereby generating a completed loading scenario by designating the subsequent priority cargo.

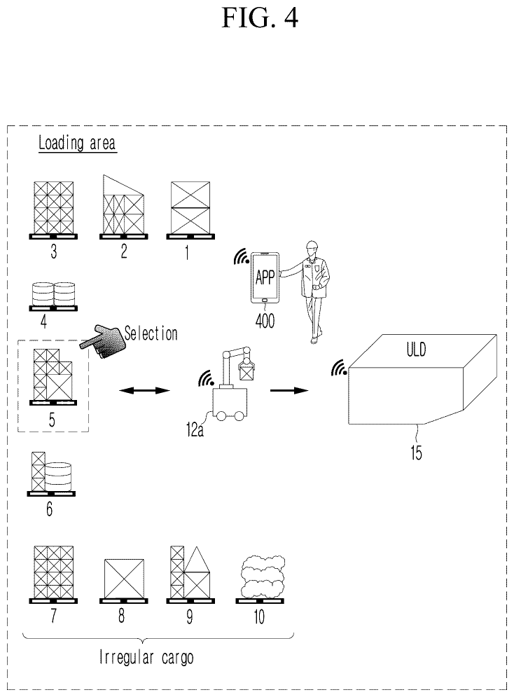

Meanwhile, FIG. 4 is a block diagram schematically showing a configuration of the worker terminal 400 according to an embodiment.

Referring to FIG. 4, the worker terminal 400 according to an embodiment may include a communication unit 410, an input unit 420, a calculation unit 430, a GUI 440 and a controller 450.

The communication unit 410 may be connected to the server 200 and/or an ERP system through wireless communication to transmit/receive data required for a logistics loading work.

The communication unit 410 may collect the cargo information located in the loading area and operation state of the logistics facility from the server 200 and collect the cargo shipment information computerized by being linked with the ERP system (not shown). The cargo shipment information may include the cargo entry/release schedule and the cargo list to be loaded.

The input unit 420 may input data (e.g., cargo information of the current loading area or the like) collected through a communication unit 140 as a condition for the loading algorithm execution. However, in an environment/situation in which wireless communication with the server 200 is not possible, the input unit 420 may input the cargo information in a manner of loading pre-defined information through a barcode (e.g., QR code) reader or barcode scan function. In addition, the inputted cargo information may include information of the cargo such as shipment information, dimensions, shapes, or the like, and when data reception in mega units is enabled, it may be configured to further include 3D modeling data.

The calculation unit 430 may execute the loading algorithm according to the input condition to calculate the loading sequence and disposal location of the cargo. The loading algorithm may be performed through the packaging simulator 300 by transmission and reception through the server 200. However, in an environment in which wireless communication with the server 200 is not possible, the calculation unit 430 may install a local simulator APP and directly proceed with the loading algorithm.

The GUI 440 may visualize and output various information for controlling the cargo loading work of the worker.

For example, the GUI 440 may display on a screen at least one of the expected loading rate derived according to the loading algorithm, a recommended priority cargo, a loading-prohibited cargo, a location of a touch interface operation unit, a loading confirmation button, or a loading location of the selected cargo.

The controller 450 may control the overall operation for the cargo loading work control of the worker according to an embodiment, and may store at least one program and data for that control.

The controller 450 may be installed with install a work instruction application APP for assisting the logistics loading work of the worker, and may control the loading algorithm for an optimal loading work instruction in a given current situation of the loading area and a scenario branch-type algorithm for deriving the plurality of expected loading rates.

Hereinafter, in an embodiment, the loading algorithm may refer to deriving one loading scenario by conducting a simulation according to a predetermined condition of a given environment. In addition, the scenario branch-type algorithm refers to recommending the cargo loading sequence based on a loading scenario having a highest loading rate among a plurality of loading scenarios derived through multiple rounds of simulation, according to variable conditions (modification/change of loading condition), in the same environment.

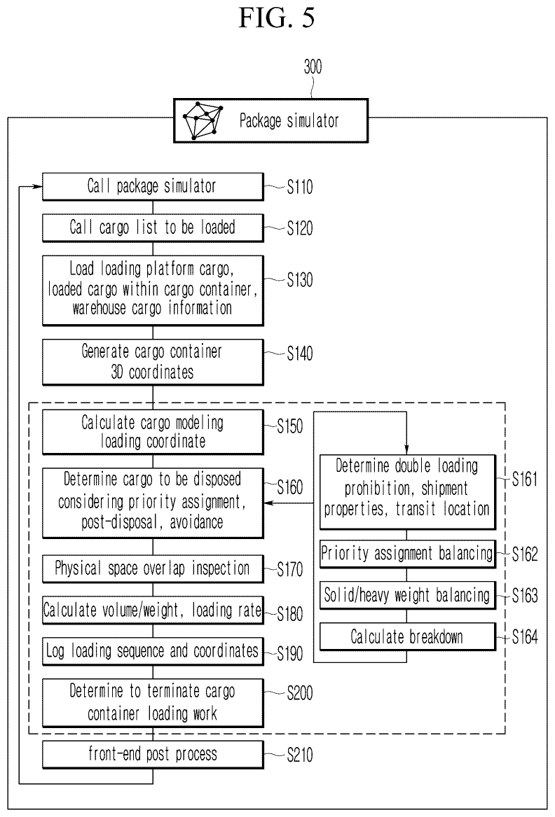

Meanwhile, FIG. 5 shows a flow of the loading algorithm utilizing the packaging simulator according to an embodiment.

Referring to FIG. 5, the worker terminal 400 according to an embodiment may call the packaging simulator 300 in order to perform the loading algorithm, at step S110. At this time, the worker terminal 400 may access the server 200 to perform the user authentication, and when the authentication is successful, it may call the packaging simulator. In addition, the server 200 may execute the packaging simulator 300, according to the call of the worker terminal 400 that was successful at the user authentication.

Hereinafter, an operation of the packaging simulator 300 by the worker terminal 400 will be described.

The packaging simulator 300 may generate the cargo list to be loaded, at step S120. The packaging simulator 300 may selectively generate the cargo list to be loaded for each destination according to a virtual simulation condition by the user or the reality-based simulation condition through linking with an upper ERP system.

The packaging simulator 300 may load the loaded cargo of the loading platform 14, the loaded cargo of the cargo container 15, and the stored cargo of the automated warehouse 13, at step S130. Here, as the cargo container 15, a ULD or a container may be designated depending on the transport vehicle. The loaded cargo of the loading platform 14 and the cargo container 15 may include at least one cargo currently disposed within a corresponding space and a physical space occupied by that cargo.

The packaging simulator 300 may generate 3D coordinates of the loaded cargo container 15, at step S140.

The packaging simulator 300 may calculate optimal coordinates with respect to the loadable cargo list filtered according to the simulation scheduling, at step S150.

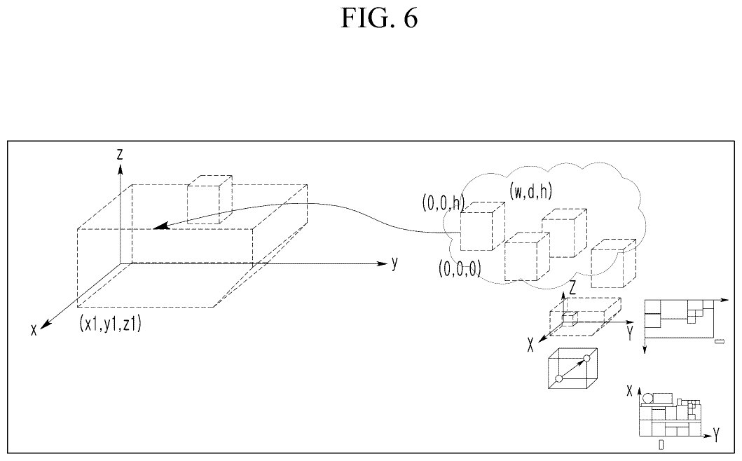

For example, FIG. 6 shows a cargo container 3D coordinates and the cargo dimension pivot state according to an embodiment represent.

Referring to FIG. 6, the packaging simulator 300 may generate 3D point coordinates according to the shape of the cargo container 15 and 3D space coordinate system (x, y, z) formed inside the cargo container. Therefore, the packaging simulator 300 may represent a physical space of the cargo loaded inside the cargo container 15 on the 3D space coordinate system. In addition, the packaging simulator 300 may generate volume coordinates of the loading-target cargo and represent it in 3D.

The packaging simulator 300 may determine a disposal-target cargo inside the cargo container 15 based on a value of a determination function of a lower unit applied with priority assignment, lower disposal, and avoidance rule, at step S160. Here, the process of determining the disposal-target cargo may include a step S161 of determining double loading prohibition, shipment properties, and a transit location; a step S162 of priority assignment balancing, in which the regular cargo is disposed in a lower portion and the irregular cargo is disposed in an upper portion; a step S163 of solid/heavy weight balancing, in which a solid and heavy weighted cargo is preferentially disposed in the lower portion; and a step S164 of calculating whether the disposed cargo is broken down.

The packaging simulator 300 may inspect whether the disposal-target cargo and a loaded cargo of the cargo container overlap in a physical space, at step S170.

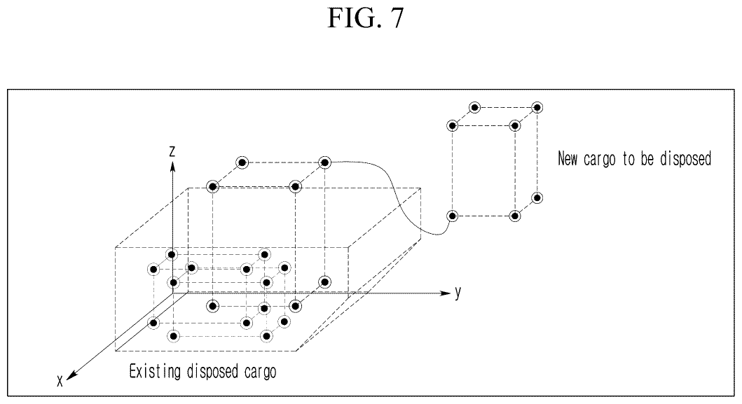

For example, FIG. 7 shows a batch cargo overlap inspection method according to an embodiment represent.

Referring to FIG. 7, whether the existing disposed cargo and a new cargo to be disposed on a 3D space coordinate system (x, y, z) within the cargo container 15 overlap in a physical space may be inspected. When the physical space overlap occurs as the inspection result, the disposal location may be modified.

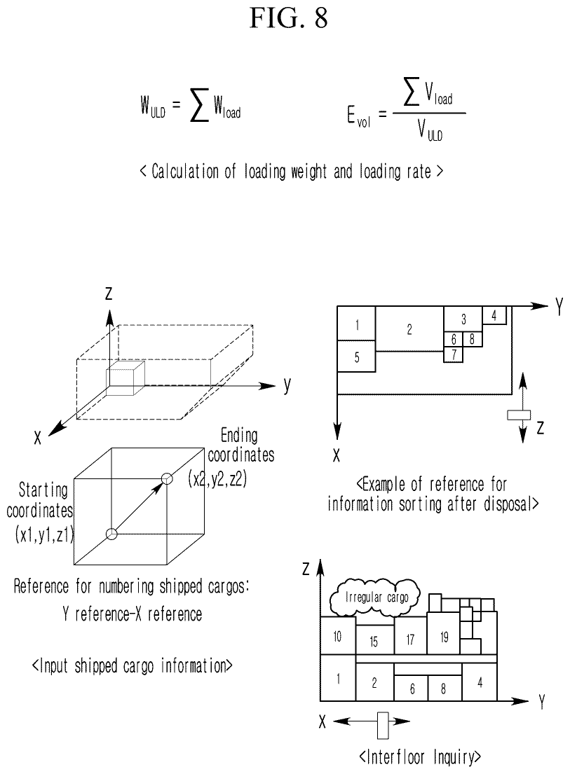

FIG. 8 shows the calculation of weight/loading rate and the loading sequence of cargos, and a coordinate logging method according to an embodiment represent.

Referring to FIG. 8, the packaging simulator 300 may calculate the loading weight and the expected loading rate of the cargo container 15 based on information of a generator library database, at step S180.

Here, the generator library database may have a backend database structure including three conditions of the cargo library, the cargo container library, and simulation scheduling, and the library may be continuously appended.

The cargo library can be modified into various forms according to the customer's requests. The cargo library may have, as its core structure, basic columns of cargo ID, file name for 3D modeling mapping, water volume, square volume, weight, dimensions (WDH), regularity, current location, destination, special shipment attributes, or the like. Data can be manually added to the cargo library, and an additional library may be configured by accumulatively updating previous histories through the cargo recognition unit 11 and the ERP system. In addition, the cargo library can create, read, update, and delete (CRUD) the key database according to the user or the purpose.

The cargo container library can modify the ULD or the container into various forms according to the customer's requests, and may include, as core configurations, cargo ID, file name for 3D modeling mapping, water volume, square volume, and attribute information such as flight. As the cargo container library, the unit load device (ULD) or the container type is determined according to the designated flight/ship. In addition, the cargo container library can CRUD the key database according to the user or the purpose.

The simulation scheduling is a database for regulating conditions, and as needed, may be generated by filtering by a user interface or prepared in advance for large-scale simulation. The simulation scheduling may include transit locations, destinations, times, logistics lines, or the like. The simulation scheduling can CRUD the key database according to the user or the purpose.

The packaging simulator 300 may generate the cargo loading list for each destination for virtual-based or reality-based simulation through the above three conditions.

In addition, the packaging simulator 300 may log the loading sequence and coordinates of the cargo disposed inside the cargo container 15, at step S190. At this time, the shipped cargo information may be input based on the numbering of the cargos disposed inside the cargo container 15, and the state information of layer-wise or width-wise loading of the disposed cargo may be graphically processed and provided.

The packaging simulator 300 may inspect whether the logged data matches the work terminating condition of the cargo container 15, and when it matches the work terminating condition, it may determine termination of the loading work, at step S200.

After determining the work termination, the packaging simulator 300 may perform a front-end post process, at step S210. At this time, the gravity and collider properties of individual cargo can be applied in the 3D virtual environment to prevent collisions. In addition, when performing the front-end post process, the packaging simulator 300 may load a modeling file on the front end (virtual 3D physics engine), may arrange numerical coordinate values of batch cargos on the loading algorithm, and may perform cross-checking on unstable loading considering gravity and collider properties, the irregular cargo and the cargo container inspection reference space interference, or the like.

Meanwhile, the worker terminal 400 is characterized by assisting logistics loading work of the worker, by deriving the expected loading rate and the scenario branch-type loading sequence based on the logistics loading situation inside the loading area, and providing the recommended cargo logic according to the derived result.

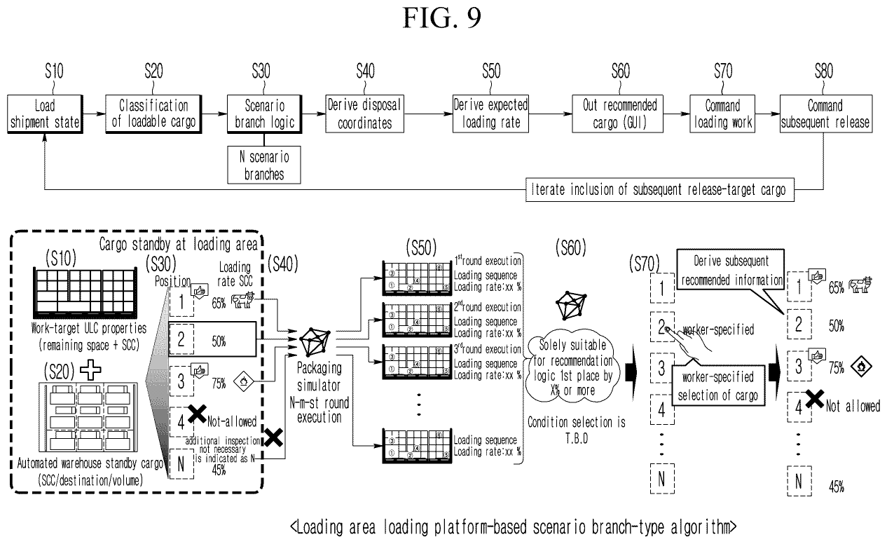

For example, FIG. 9 illustrates the loading area loading platform-based scenario branch-type algorithm applied to the worker terminal according to an embodiment.

FIG. 9 shows the flow and status of each step in perform the loading area loading platform-based scenario branch-type algorithm by the worker terminal 400. Hereinafter, the loading area loading platform-based scenario branch-type loading algorithm using the worker terminal 400 according to an embodiment will be described in detail.

The worker terminal 400 may load shipment state of the current work-target cargo container 15 and accumulated shipment properties (SCC) through the server 200 may, at step S10. Through this, the worker terminal 400 may identify a remaining space obtained by subtracting the shipped cargo from the entire space of the cargo container 15.

The worker terminal 400 may filter shipment-prohibited cargos through inspection of shipment properties (SCC) of the cargo existing in the loading platform 14 of the loading area to classify the loadable cargo, at the step S20. At this time, the worker terminal 400 may filter the cargo that is not possible to be shipped in the cargo container 15 or transport vehicle due to risks of fire, collapse, or the like, in advance, based on the shipment properties inspection.

The worker terminal 400 may branch a scenario targeting the loadable cargo at step S30, and may derive disposal coordinates with respect to a subsequent loadable cargo, at step S40. At this time, the worker terminal 400 may limit the number of scenario branches through a separate rule based on a calculation load of the packaging simulator 300.

The worker terminal 400 may perform a loading algorithm calculation utilizing the packaging simulator 300 based on the branched scenario to derive the plurality of expected loading rates for each scenario branch, at step S50 (see FIG. 5). When needed, the worker terminal 400 may further perform the loading algorithm calculation based on the cargo information having entered the logistics terminal other than the loading area and being standby in the automated warehouse or existing in entry reservation information to derive the expected loading rate for each scenario branch.

The worker terminal 400 may sort the expected loading rate for each derived scenario branch with respect to each corresponding cargo and output a priority recommended cargo matching a recommended cargo logic through the GUI 440, at step S60. Accordingly, the worker may be enabled to select an optimal loaded cargo having the highest expected loading rate referring to the information output to the GUI 440.

When a specific cargo is selected through the GUI 440 by the worker, the worker terminal 400 may transmit the loading work instruction of the specific cargo to the server 200, at step S70.

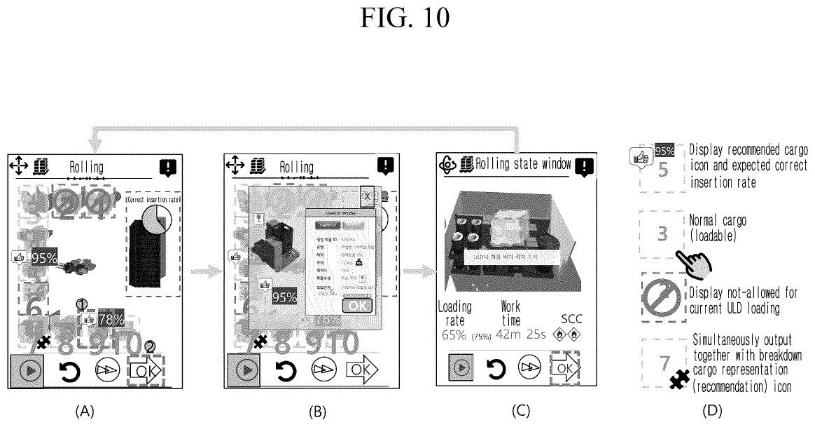

In addition, when the loading work of the specific cargo is completed, the worker terminal 400 may proceed to the step S10 for a subsequent releasing work, at step S80. Meanwhile, FIG. 10 shows a GUI output form of the worker terminal 400 in a loading work according to an embodiment.

FIG. 10 may be understood as GUI screens output in the worker terminal 400, corresponding to the step S60 to the step S70 of FIG. 9 described above.

First, the section (A) of FIG. 10 shows the loading area view screen of a GUI 400.

Referring to the section (A) of FIG. 10, the GUI 440 of the worker terminal 400 may display the loading platform position and the loading platform IDs 1 to 10 existing in the loading area through the loading area view screen, and may output a correct insertion rate status with respect to the current work-target cargo container 15 in the form of a graph and/or percentage (or status/total amount).

At this time, as defined in the section (D) of FIG. 10, the GUI 440 may display information such as the expected loading rate of the cargo, whether the cargo can be loaded, whether the cargo is broken down, and recommended cargo, with respect to each loading platforms 1 to 10, in the form of icons. In addition, in the case of recommended cargos classified according to a recommended cargo selection logic, it may derive a recommended icon graphic resource and the expected loading rate into a 3D scene, thereby strengthening the convenience in the worker's selection.

The section (B) of FIG. 10 represents the cargo selection confirmation screen of the GUI.

Referring to the section (B) of FIG. 10, when the worker selects (inputs) a specific cargo (cargo ID) among the loading platform icons that can be selected from the loading area view screen, the GUI 440 may output detailed information on the corresponding cargo. In addition, when the worker selects “OK button” within the 2D user interface, the GUI 440 may automatically select the cargo having the highest expected loading rate ranking and output detailed information on the corresponding cargo.

The section (C) of FIG. 10 shows a cargo container loading location view screen of a GUI.

When referring to the section (C) of FIG. 10, the GUI 440 may output the disposal location considering loaded status inside the cargo container 15 with respect to the cargo previously selected by the worker, and work status information including a loading rate of a current cargo container 15, a work time, and shipment properties (SCC). At this time, when the worker inputs ‘OK’ button, the GUI 440 may transmit the loading work instruction based on the corresponding work status information to the server 200.

Thereafter, the GUI 440 may treat the loading work instruction to have been completed in the computer system, and may return to the screen of the section (A) of FIG. 10, to repeat the process of selecting the subsequent cargo.

In addition, in the screen of the section (C) of FIG. 10, the GUI 440 may provide a back function via a ‘BACK’ button or other cancelable manipulation device until the loading work instruction is completed.

Meanwhile, upon user's request or H/W availability, the GUI 440 of the worker terminal 400 may be configured with advanced functions including inquiry and statistics functions, manual modification, and additional information output menu.

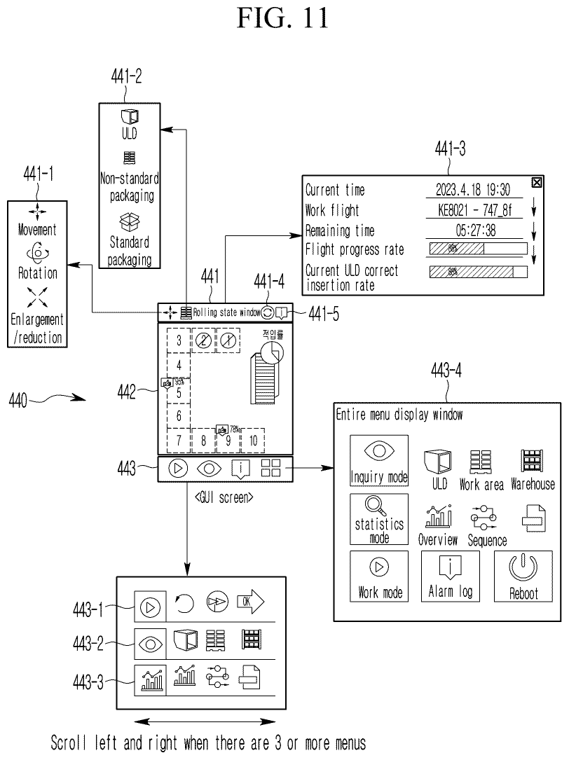

For example, FIG. 11 illustrates an additional function applied to a GUI of the worker terminal 400 according to an embodiment.

Referring to FIG. 11, the GUI 440 screen of the worker terminal 400 may be largely divided into a status bar display unit 441, a main screen display unit 442, and a menu bar (bottom navigator) display unit 443. Hereinafter, detailed menu included in each display unit may be displayed through a sub-screen that is popped up when inputting the selection.

The status bar display unit 441 may include a manipulation menu 441-1 for moving, rotating, enlarging, or reducing the display screen or the object, a work menu 441-2 for displaying or switching the current work mode, a rolling state menu 441-3 for displaying a real-time cargo container (ULD) work progress status, a refresh menu 441-4 for renewing the screen, an alarm menu 141-5 for displaying the occurrence of a worker alarm through an icon (Flicker), or the like.

The main screen display unit 442 displays the loading area view screen including the automated warehouse 13, the loading platform 14, the cargo container 15, and the cargos loaded on each space (see the description in connection with FIG. 10).

The menu bar display unit 443 may include a work mode menu 443-1 for automatically switching views according to main mode cargo selection/confirmation for progressing the loading work, an inquiry mode menu 443-2 for work status monitoring and manual instruction/repair, a statistics mode menu 443-3 for providing statistics data calculated according to the work status monitoring, and a full menu 443-4 for displaying menus included in each display unit in sub-screens, or the like.

While the exemplary embodiments of the present invention have been described hereinabove, the present invention is not limited only the exemplary embodiments and various other changes can be made.

For example, when there is only one packaging simulator 300, in the loading area loading platform-based scenario branch-type algorithm according to an embodiment illustrated in FIG. 9, the calculation is sequentially requested depending on the branched scenario so that a work delay due to the calculation load may occur.

Accordingly, the packaging simulator 300 may establish a simulator in a parallel computing structure through a virtual computer, to parallel-process the branched scenario, and the algorithm may be established as a calculation method based on a CPU rather than a GPU according to an advanced calculation request. Therefore, a branch-type algorithm can be rapidly processed, thereby preventing the calculation delay.

In addition, when performing the loading area loading platform-based scenario branch-type algorithm according to FIG. 9, the worker terminal 400 may employ a method in which processing of some cargo of the loading area having lower loading rate ranking is skipped for several rounds (N rounds) skip based on the calculation load.

In addition, when outputting the cargo recommended icon through the GUI 440, the worker terminal 400 can sort them in a high priority based on the expected loading rate high, and limit the output to only the top specified number (e.g., N) of cargos.

In addition, the worker terminal 400 may manage the number of times the worker selects the cargo recommended icon as a key performance indicator (KPI), to indirectly verify the validity of the simulation algorithm and derive improvement plans.

In addition, when performing a subsequent loading algorithm iteration loading after completing the cargo loading work instruction according to the worker's selection, the worker terminal 400 may apply an option to include a cargo to be placed in the lower priority. For example, supposing that the worker selects the cargo having the highest expected loading rate, the cargo having the subsequently high expected loading rate is likely to be selected to be released in the loading algorithm.

Accordingly, when determining whether the work with respect to the cargo container 15 is completed, the worker terminal 400 basically follows the loading algorithm calculation utilizing the packaging simulator 300, but manually process completion of loading with respect to the current cargo container loading under the system error or the inspection officer's decision.

As such, according to an embodiment, the expected loading rate and the scenario branch-type loading sequence based on logistics loading situation in a work area of the logistics terminal may be derived through the worker terminal, and a recommended cargo may be provided according to the derived result, thereby improving the cargo loading efficiency.

In addition, by improving the computerized worker terminal to derive the expected loading rate of available cargos based on the worker's selection and to monitor loading operations and instruct loading operations through the release of priority cargo, it is possible to ensure consistent cargo loading efficiency without being affected by the worker's skill level.

In addition, by installing a work instruction application (APP) on the worker's terminal to assist the worker's logistics loading work and thereby controlling the optimal loading work instruction in a given environment of the size and shape of the cargo container and the volumetric weight of the cargo, it is possible to reduce the loading work man-hours, time, and cost.

The exemplary embodiments of the present disclosure described above are not only implemented by the apparatus and the method, but may be implemented by a program for realizing functions corresponding to the configuration of the embodiments of the present disclosure or a recording medium on which the program is recorded.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A logistics loading work control system, comprising:
a server configured to mirror facility data of an actual logistics facility and a virtual environment;
a packaging simulator configured to calculate cargo information corresponding to a loading area received from the server through a loading algorithm and predict priority cargo information in a sequence of highest loading efficiency with respect to a current work-target cargo container; and
a worker terminal configured to assist a logistics loading work of a worker by deriving a loading sequence and an expected loading rate based on a logistics loading situation inside the loading area through the packaging simulator and providing a recommended cargo logic according to the derived result.

2. The logistics loading work control system of claim 1, wherein the packaging simulator is integrated into the server or installed in the worker terminal in an on-board format or by installing a client service program APP.

3. The logistics loading work control system of claim 1, wherein the worker terminal is configured to display the priority cargo information and a plurality of expected loading rates derived through the loading algorithm of the packaging simulator through a graphical user interface (GUI), and receive the specific cargo information selected by the worker and transmit a loading work instruction to the server.

4. The logistics loading work control system of claim 1, wherein the worker terminal comprises:
a communication unit connected to the server or an enterprise resource planning (ERP) system through wireless communication to transmit/receive data required for the logistics loading work;
an input unit configured to input the cargo information of a current loading area collected through the communication unit as a condition for the loading algorithm execution;
a calculation unit configured to execute the loading algorithm according to an input condition to calculate the loading sequence and a disposal location of the cargo;
a graphical user interface (GUI) configured to visualize and output various information for controlling the cargo loading work of the worker; and
a controller installed with a work instruction application for assisting the logistics loading work of the worker, and configured to control the loading algorithm for the loading work instruction in a current situation of the loading area and a scenario branch-type algorithm for deriving the plurality of expected loading rates.

5. The logistics loading work control system of claim 4, wherein the communication unit is configured to collect the cargo information located in the loading area and operation state of the logistics facility from the server and collect the cargo shipment information computerized by being linked with the ERP system.

6. The logistics loading work control system of claim 4, wherein, in an environment in which wireless communication with the server is not possible, the input unit inputs the cargo information in a manner of loading pre-defined information through a barcode or QR scan function.

7. The logistics loading work control system of claim 4, wherein the GUI is configured to display on a screen at least one of the expected loading rate derived according to the loading algorithm, a recommended priority cargo, a loading-prohibited cargo, a location of a touch interface operation unit, a loading confirmation button, or a loading location of the selected cargo.

8. The logistics loading work control system of claim 4, wherein the GUI is configured to display a loading platform position and loading platform ID existing in the loading area through a loading area view screen, and output a correct insertion rate status with respect to the current work-target cargo container in the form of a graph or percentage.

9. The logistics loading work control system of claim 8, wherein the GUI is configured to display information on at least one of the expected loading rate of the cargo, whether the cargo can be loaded, whether the cargo is broken down, or a priority recommended cargo with respect to each loading platform, in the form of icons, and in the case of recommended cargos classified according to a recommended cargo selection logic, derive a recommended icon graphic resource and the expected loading rate into a 3D scene.

10. The logistics loading work control system of claim 8, wherein when the worker selects a specific cargo among loading platform icons that can be selected from the loading area view screen, the GUI is configured to output detailed information on the corresponding cargo.

11. The logistics loading work control system of claim 4, wherein the GUI is configured to output the disposal location considering loaded status inside the cargo container with respect to the cargo selected by the worker, and work status information comprising a loading rate of a current cargo container, a work time, and shipment properties, through a cargo container loading location view screen.

12. A logistics loading work control method of a worker terminal, the method being linked with a server of a logistics terminal, the method comprising:
loading, by the worker terminal, shipment state and accumulated shipment properties of a current work-target cargo container, through the server;
filtering, by the worker terminal, shipment-prohibited cargos through inspection of shipment properties of the cargo existing in a loading platform of a loading area to classify a loadable cargo;
branching, by the worker terminal, a scenario targeting the loadable cargo and deriving disposal coordinates with respect to a subsequent loadable cargo;
performing, by the worker terminal, a loading algorithm calculation utilizing a packaging simulator based on the branched scenario to derive an expected loading rate for each scenario branch;
sorting, by the worker terminal, the expected loading rate for each derived scenario branch with respect to each corresponding cargo; and
outputting, by the worker terminal, a priority recommended cargo matching a recommended cargo logic through a graphical user interface (GUI).

13. The logistics loading work control method of claim 12, further comprising, after outputting the priority recommended cargo through the GUI, transmitting a loading work instruction of the specific cargo to the server, when a specific cargo is selected through the GUI by a worker.

14. The logistics loading work control method of claim 12, wherein branching the scenario targeting the loadable cargo comprises limiting the number of scenario branches through a separate rule based on a calculation load of the packaging simulator.

15. The logistics loading work control method of claim 12, wherein deriving the expected loading rate for each scenario branch further performs a loading algorithm calculation based on a cargo information being standby in an automated warehouse or existing in entry reservation information to derive the expected loading rate for each scenario branch.

16. The logistics loading work control method of claim 12, wherein deriving the expected loading rate for each scenario branch comprises:
loading a loaded cargo of the loading platform, a loaded cargo of the cargo container, and a stored cargo of an automated warehouse, through the packaging simulator;
generating 3D coordinates of the loaded cargo container and calculating the loadable cargo list target coordinates;
determining a disposal-target cargo inside the cargo container based on a value of a determination function of a lower unit applied with priority assignment, lower disposal, and avoidance rule;
inspecting whether the disposal-target cargo and the loaded cargo of the cargo container overlap in a physical space, and modifying the disposal location when a physical space overlap occurs; and
calculating a loading weight and expected loading rate of the cargo container based on information of a generator library database comprising three conditions of a cargo library, a cargo container library, and simulation scheduling.

17. The logistics loading work control method of claim 16, wherein determining the batch cargo comprises:
determining double loading prohibition, shipment properties, and a transit location;
priority assignment balancing, for disposing a regular cargo in a lower portion and an irregular cargo in an upper portion;
solid/heavy weight balancing, for preferentially disposing a solid and heavy weighted cargo in the lower portion; and
calculating whether the disposed cargo is broken down.

18. The logistics loading work control method of claim 12, wherein the outputting the priority recommended cargo through the GUI comprises further displaying at least one of the expected loading rate derived according to the loading algorithm, a loading-prohibited cargo, a location of a touch interface operation unit, a loading confirmation button, or a loading location of the selected cargo.

19. The logistics loading work control method of claim 12, wherein outputting the priority recommended cargo through the GUI comprises, when the worker selects a specific cargo among loading area view screen of loading platform icons that can be selected from the GUI, outputting detailed information on the corresponding cargo.

20. The logistics loading work control method of claim 12, wherein outputting the priority recommended cargo through the GUI comprises outputting the disposal location considering loaded status inside the cargo container with respect to the cargo selected by the worker, and work status information comprising a loading rate of a current cargo container, a work time, and shipment properties, through a cargo container loading location view screen of the GUI.
